(19) United States
(12) Patent Application Publication
(10) Pub. No.: US 2006/0101516 A1
(43) Pub. Date: May 11, 2006

(54) Honeynet farms as an early warning system for production networks

(76) Inventors: Sushanthan Sudaharan, Beltsville, MD (US); Srikrishna Dammalapati, South Riding, VA (US); Sijan K. Rai, Beltsville, MD (US); Duminda Wijesekera, McLean, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 11/248,001

(22) Filed: Oct. 12, 2005

Related U.S. Application Data
(60) Provisional application No. 60/617,077, filed on Oct. 12, 2004.

(51) Int. Cl. G06F 12/14

(52) U.S. Cl. 726/23

(57) ABSTRACT

The present invention deals with a honeynet based actionable warning system. Automatic decisions to combat attacks learned through a honeynet may be generated by receiving data originating from one or more network analyzers. The data may be classified into a hierarchy of predetermined attributes, as well as sorted using these attributes. Topics relating to one or more of predetermined attributes may be communicated to a client. A request to implement topics may be received from the client. Notification may be sent to the client that includes information related to the request.

### CROSS-REFERENCE TO RELATED APPLICATIONS

The present application claims the benefit of provisional patent application: Ser. No. 60/617,077 to Sudaharan et al., filed on Oct. 12, 2004, entitled “Honeynet Farms as an Early Warning System for Production Networks,” which is hereby incorporated by reference.

### REFERENCE TO COMPUTER PROGRAM LISTING APPENDIX ON A COMPACT DISC

Two copies of a single compact disc (Compact Disc), respectively labeled Copy 1 and Copy 2, are hereby incorporated by reference in their entirety. Both Compact Discs are identical to each other. The files on this Computer Program Listing Appendix describe an example of an agent system that may be used for managing online alerts and reaction modules. File “hp.properties” was created on Compact Disc on Oct. 12, 2005 and has a size of 366 bytes. File “jdm_logging.properties” was created on Compact Disc on Oct. 12, 2005 and has a size of 845 bytes. File “jla_logging.properties” was created on Compact Disc on Oct. 12, 2005 and has a size of 845 bytes. File “JDM” was created on Compact Disc on Oct. 12, 2005 and has a size of 4,104 bytes. File “SamplePublisher” was created on Compact Disc on Oct. 12, 2005 and has a size of 2,079 bytes. File “SimpleUDP” was created on Compact Disc on Oct. 12, 2005 and has a size of 433 bytes. File “WestHawkTrap” was created on Compact Disc on Oct. 12, 2005 and has a size of 1,410 bytes. File “Commander” was created on Compact Disc on Oct. 12, 2005 and has a size of 626 bytes. File “JLA” was created on Compact Disc on Oct. 12, 2005 and has a size of 2,570 bytes. File “MapListener” was created on Compact Disc on Oct. 12, 2005 and has a size of 2,155 bytes. File “TestCommand” was created on Compact Disc on Oct. 12, 2005 and has a size of 331 bytes. File “TextListener” was created on Compact Disc on Oct. 12, 2005 and has a size of 871 bytes. File “ContextHelper” was created on Compact Disc on Oct. 12, 2005 and has a size of 1,080 bytes.

### BACKGROUND OF THE INVENTION

Many online intrusion detection and prevention mechanisms exist to dissuade and monitor the movement of uninvited traffic in Intranets.

A similar line of study involves simulating networks by responding to network packets by a single machine so that the intruder actions can be studied—commonly referred to as honeynets.

Currently available ones are stand-alone software tools that share their knowledge offline.

Thus, the information obtained from such a collection of honeynets has to be correlated. In order to use honeynet outputs for real-time counter actions, either defensive or offensive, while intrusions occur, there is a need for a hardware-assisted honeynet out of a collection of routers and firewalls. Additionally, it would be helpful to have online attack identification and reaction modules to counteract actions known to be malicious or highly suspicious. It would also be helpful to have an intelligence-gathering module that can issue online alerts, which can be fed to appropriately secure production networks in migrating their operational risks. Risk mitigation can be dependent upon the certainty and severity of alerts. It can also range from defensive actions such as limiting accesses by dynamically switching to more restrictive filtering policies at border gateways or offensive actions, such as hacker tracing and/or counterattacking appropriately identified targets.

### BRIEF SUMMARY OF THE INVENTION

The present invention presents one aspect of generating automatic decisions in a honeynet farm based actionable early warning system. It may receive data originating from at least one network analyzer, where the network analyzer may be part of at least one honeynet. It may also generate classified data by classifying said data into a hierarchy of predetermined attributes. Additionally, it may sort the classified data by using at least one of the predetermined attributes. Furthermore, it may communicate topics related to one or more of the predetermined attributes to a client. Moreover, it may receive a request from the client to implement topics. And, it may notify the client with information related to the request.

In yet a further aspect of the invention, topics can be located at a distribution point. This distribution point can be a server. It can be secure and may even be centralized within a honeynet or located elsewhere.

In yet a further aspect of the invention, the data may be analyzed in real-time. In addition, the data can be analyzed using a variety of formats, such as signature, statistical anomaly and flow-based.

In yet a further aspect of the invention, the accuracy of the traffic may be measured. Along with the traffic, the time taken to identify potential alarms or attacks may be measured.

In yet a further aspect of the invention, security policies may be changed with new and/or more secure policies. Furthermore, an access list may be created on the fly and automatically loaded using a network management system.

One advantage of the present invention is that it is a distributed system with multiple agents that can collect and share data.

Another advantage of the present invention is that it can constantly scan traffic for malicious activities. The result of constant scanning can be fed to multiple clients who can take individual actions.

Another advantage of the present invention is that is can automatically activate scripts based on event data. It can also allow for autonomic responses, such as changing policies on firewalls in real-time as a defense measure or start a counter attack as an offensive measure.

Another advantage of the present invention is that it can be customized to meet specific needs.

Another advantage of the present invention is that it may only need limited hardware upgrading with little or no special network communications. The modular system can be easily upgraded or expanded to provide the advantage of a distributed design.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated in and form a part of the specification, illustrate an embodiment of the present invention and, together with the description, serve to explain the principles of the invention.

FIG. 1 is a block diagram showing a honeynet farm based actionable early warning system as per an embodiment of the present invention.

FIG. 2 is a block diagram showing a honeynet farm based actionable early warning system as per an embodiment of the present invention.

FIG. 3 is an aspect of the present invention showing the correlation among a multitude of automatic decision makers, distribution point, and listening agents.

FIG. 4 is a flow diagram showing the generation of automatic decisions as per an aspect of an embodiment of the present invention.

FIG. 5 shows an example of a honeynet setup.

FIG. 6 shows an example of a honeynet demonstration setup.

FIG. 7 is an aspect of the present invention showing the correlation among a multitude of automatic decision makers, distribution point, and listening agents using Java.

FIG. 8 shows an example of an interactive honeynet farm.

### DETAILED DESCRIPTION OF THE INVENTION

Embodiments of the present invention comprise a honeynet farm based actionable early warning system. Composed of one or more honeynets, the tangible computer readable medium can aid a user or administrator to learn attack and/or probe techniques that may be aimed to infiltrate a network. By allowing potential attackers to access a honeynet, which may serve as a dummy network, and learning their various infiltration techniques, the tangible computer readable medium may automatically generate decisions for users and/or administrators in defending or combating against present and future unauthorized access of a network.

A honeynet is an architecture, as opposed to a product (e.g., a computer software), that comprises one or more honeypots. A honeypot is a generally versatile tool that serves as a network decoy for distracting attackers from more valuable data sources on a network. It also helps network administrators determine their network's weaknesses. Typically, a honeypot has no production value. Rather, its value lies in unauthorized or illicit use of the information system resource. Any data entering or leaving a honeypot may be considered a probe, attack or compromise. By learning how an attacker can gain entry into the decoy network, administrators can use that knowledge to bolster their network's defense systems by closing those loopholes in the real networks.

In particular, a honeynet is a type of a high-interaction honeypot designed to capture data that may pose threats. High-interaction honeypots generally uses real operating systems, applications and services for hackers to interact with One advantage is that high-interaction honeypots allow network administrators to capture more information about an attacker's intrusion by seeing what tools an attacker uses. Moreover, a high-interaction honeypot is less likely to be discovered by an attacker. However, because of their complexity, they are more difficult to deploy and maintain.

High-interaction honeypots differ from low-interaction honeypots (such as Honeyd, KFSensor and BackOfficer Friendly), which tend to provide limited interaction emulated operating systems, applications and services. Although low-interaction honeypots may be easy to deploy and maintain, these less complex systems are more easily detectable. Also, administrators tend to only gain limited information about an attacker and his/her attack tactics.

A honeynet is neither a single computer nor does it function as a single computer. A honeynet usually differs from a honeypot in that a honeynet is an architecture having a system of one or more honeypots. This system can include a plurality of similar or different databases, servers, webservers, routers or printers. Furthermore, within this architecture, a network of systems may be designed to allow interactions with hackers. The network is controllable; all activities that occur within can be monitored.

Once the architecture is created, the honeynet needs to be deployed to attract hostile activity. It is well known in the art that successful deployment requires Data Control and Data Capture. Data Control defines how activity is contained within the honeynet without a hacker knowing it. Data Capture defines capturing all of the hacker's activity without a hacker knowing it. Of the two, Data Control often takes priority over Data Capture.

In general, Data Control is containment of an activity and helps minimize the risk of a hacker using a honeynet to attack or harm non-honeynet systems. Data Control calls for a balance of freedom afforded to a hacker to access the honeynet and the activities restricted. When more freedom is given to a hacker, the risk of the hacker circumventing Data Control and harming non-honeynet systems increases. However, when more activities are restricted, it becomes harder to learn how a hacker can infiltrate an organization's network. One way to achieve successful deployment is implementing multiple layers in the Data Control. Examples of layers include, but are not limited to, counting outbound connections, intrusion prevention gateways, or bandwidth restrictions. Combining several different mechanisms may help protect against a single point of failure, especially when dealing with new or unknown attacks. The Honeynet Project has also publicly recommended that Data Control be operated in a fail closed manner. Fail closed manner generally means that the honeynet architecture may block all outbound activities, as opposed to allowing it, if there is a failure in any mechanism (e.g., a process dies, hard drive is full, or rules are misconfigured).

An ordinary honeynet demands Data Control to meet certain goals to function properly. For example, it should be both implementable automatically and manually. There ought to be at least two layers of Data Control to protect against failure. Data Control failures should not leave the system in an open state, which allow accesses to and from the honeypot. It should be able to maintain the state of all inbound and outbound connections. An administrator ought to be able to configure Data Control enforcement at any time, including remotely. Connections should be difficult to detect. Automated alerting should take effect when a honeypot is compromised.

Data Capture refers to the monitoring and logging of a hacker's activities within the honeynet. Once data is captured, it is usually analyzed to learn the tools, tactics and motives of hackers. Similar to Data Control, combining several mechanisms for capturing activity can be crucial. This combination can help in both piecing a hacker's actions together, as well as preventing a single point of failure. In general, the more layers of information that are captured tend to lead to more learned information. The Honeynet Project has recommended taking encryption into consideration, while minimizing the ability of hackers from detecting capturing mechanisms. Minimization may be accomplished in numerous ways, such as making as few modifications to the honeynet as possible, and logging and storing captured data on a separate, secured system.

Like Data Control, Data Capture needs to meet certain goals as well. For instance, honeynet captured data should not be stored locally on the honeypot. Data Capture should be kept clean to avoid or minimize data pollution. Data pollution may contaminate a honeynet, and thus invalidate captured data. Data pollution is any non-standard activity to an environment. One example would be an administrator testing a toll by attacking a honeypot. Inbound/outbound connections (e.g., firewall logs), network activity (e.g., full packet captures) and system activity ought to be captured and archived for at least 1 year. Activities should be remotely viewable in real-time. Data viewed should be automatically archived for future analysis. A standardized log should be maintained for every honeypot deployed. Additionally, a standardized, detailed write-up of every honeypot compromised should be maintained. It is also recommended that a honeynet gateway's Data Capture use the UCT time zone. Resources used to capture data ought to be secured against any compromise to protect the data's integrity.

However, unlike Data Control, where a minimum standard is not apparent because of various and different implementable technologies and approaches, Data Capture tends to demand a minimum standard that identifies what data and in what format data should be captured at a honeynet. For example, network activity (e.g., packets and full packet payload) should be captured in pcap binary format (e.g., OpenBSD lipcap standards) and rotated on a daily basis. Also, firewall logs should be converted to IPTables ASCII format. Additionally, system activity can use a data capture tool, such as Sebek, that serves as a hidden kernel module that captures and dumps host activity to the network, while preventing hacker from sniffing traffic based on a magic number and/or dst port.

In addition to Data Control and Data Capture, a third requirement, namely Data Collection, may be necessary. Data Collection typically applies only to organizations having multiple honeynets in distributed environments. This aspect maybe particularly the case where the honeynet is to be part of a distributed network. It may be useful to have a central location to collect and store captured data where organizations have multiple honeynets logically or physically distributed worldwide. However, where organizations have only one honeynet, Data Control and Data Capture may be sufficient.

Like Data Control and Data Capture, Data Collection also has certain goals to achieve. For example, there should be some form of honeynet naming convention and mapping in place so that the type of site and a unique identifier can be maintained for each honeynet. There ought to be secure transmission of captured data from sensors to a data collector for ensuring the confidentiality, integrity and authenticity of data. Organizations should have the option of keeping the data anonymous. This option may be accomplished by allowing organizations to keep their source IP addresses and other information confidential. A distributed honeynet should be able to be standardized on a network time protocol for proper synchronization of captured data in a honeynet.

Similar to Data Capture, Data Collection also has a standard that should be followed. Such standard helps determine what data, format and/or naming convention data should be sent to a central collection point. For example, honeynet data types can include pcap binary logs and firewall logs in ASCII format, and can be automatically forwarded daily to the central point. A naming convention for pcap binary logs may follow the format: yearmonthday-identifier-pcap.log (e.g., 20050825-roo-001a-pcap.log). As for firewall logs in ASCII format, the naming convention may be yearmonthday-identifier-fwlogs.txt (e.g., 20050825-roo-001a-fwlogs.txt). Moreover, each organization and its honeynet should receive a unique identifier.

There are many types of risks that a honeynet addresses. These include harm, detection, disabling and violation. Harm exists when a honeynet is used to attack or harm other, non-honeynet systems. For example, a hacker may break into a honeynet and launch an unfamiliar outbound attack on its intended victim. Detection refers to the identification or exposure of a honeynet. Once a honeynet is identified or exposed, its value is dramatically reduced because hackers can now ignore or bypass the honeynet, and thus eliminate the honeynet's capability of capturing information. For example, if a honeynet blocks 10 outbound connection attempts, but a hacker has detected its identity, the hacker need only attempt 11 or more outbound connection attempts and watch the 11^{th} one consistently fail. Alternatively, if packets are being modified as they pass a honeynet, the hacker simply needs to send packets with a known payload to systems they control to see if they are modified in transit. Also, if traffic is tunneled in a “honey farm,” the added latency may indicate that a honeynet is in place. Or, the hacker may use methods to detect the presence of local Data Capture capabilities on the honeypot itself. Disabling honeynet functionality is another form of risk, where hackers can disable Data Control and/or Data Capture capabilities without the administrator's knowledge. Once disabled, a hacker could feed bogus data to make administrators think Data Capture is still functioning and recording. Violation is the catchall term for remaining risks, such as criminal activities. For example, hackers may compromise a honeynet to steal a person's identity or even upload/distribute illegal content, such as pirated movies and music.

Because risks can never be completely eliminated, minimizing risks is perhaps the next best avenue. To help minimize these risks, human monitoring and customization are recommended. Human monitoring refers to having a trained professional monitor and analyze a honeynet in real-time. Customization involves modifying one's honeynet with some degree of randomness to fit one's needs. Making one's honeynet different is important because honeynet technologies are OpenSource and publicly available materials. Thus, anyone, including hackers, has access to default settings.

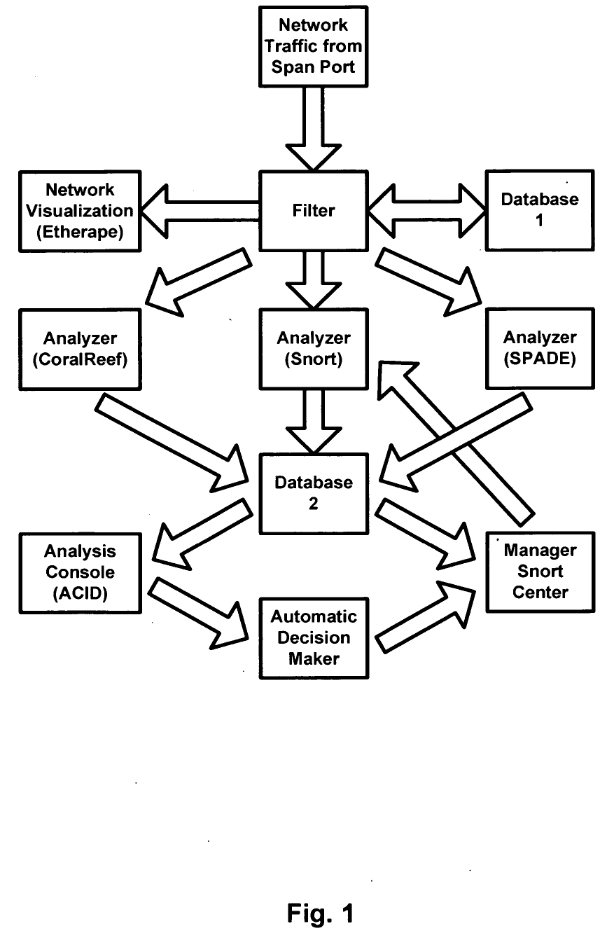

Referring to the figures, FIG. 1 illustrates an aspect of a honeynet of the present invention for generating automatic decisions in a honeynet farm based actionable early warning system. A honeynet farm is a multitude of honeynets. For each honeynet, network traffic data may be monitored from a span port and sorted into a filter. The filter is configurable to determine which actions or data on the honeynet can be deemed as an attack. Taking the network traffic data, the filter can process and/or store data into a first database. Any data stored in the first database may be retrieved by the filter. Additionally, the filter may also filter the network traffic data into a network visualization tool for displaying network traffic within certain connections. It may even display all possible kinds of attacks within the network. However, such network visualization tool may not be necessary as visualization features can be incorporated into a network analyzer.

One or more network analyzers may obtain and analyze network traffic data received from the filter. A network analyzer may function as an intrusion detection system (IDS). IDS is capable of performing real time analysis and packet logging on IP networks. Some IDSs may be open source, while others are not. Using flexible rules language, IDSs may also perform an analysis on specific or groups of protocols, search for and/or match content with the network traffic data, and detect a variety of attacks and probes, such as but not limited to buffer overflows, stealth port scans, CGI attacks, SMB probes, OS fingerprinting attempts, etc.

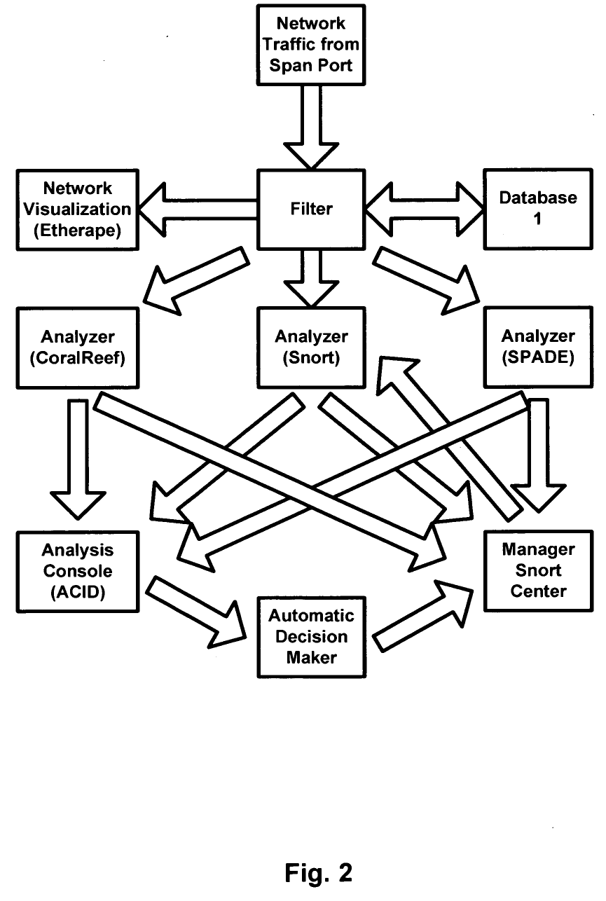

Results of analyzed data may be correlated by one or more of these network analyzers. These correlated results may be forwarded to an intelligence center, may comprise a second database, analysis console, feedback controller, and an automatic decision maker. Correlated results may first be forwarded to the second database. The second database may be used for storing the correlated results. This database may in turn forward the correlated results to the analysis console, which may be used to further analyze the correlated results. The second database may also forward correlated results to the feedback controller. The feedback controller, which may be associated with a specific network analyzer, may be used to fine tune the filter. However, the feedback controller is merely preferable but not essential because not every network analyzer will have an associated feedback controller. Moreover, the present invention does not necessarily demand the presence of the second database, as indicated in FIG. 2. The present invention may operate in real-time with or without the second database. Without a second database, correlated results would flow directly from a network analyzer to either the analysis console or feedback controller or both.

An automatic decision maker may receive the analyzed correlated results from the analysis console. This further analyzed data may contain alerts generated by the network analyzer and/or analysis console. Additionally, the automatic decision maker may receive data from the feedback controller. Data may include information outlining, detailing and/or verifying which data is further sorted from the network traffic data that may be of interest. Data may also include verification and/or confirmation of the fine tuning of the filter.

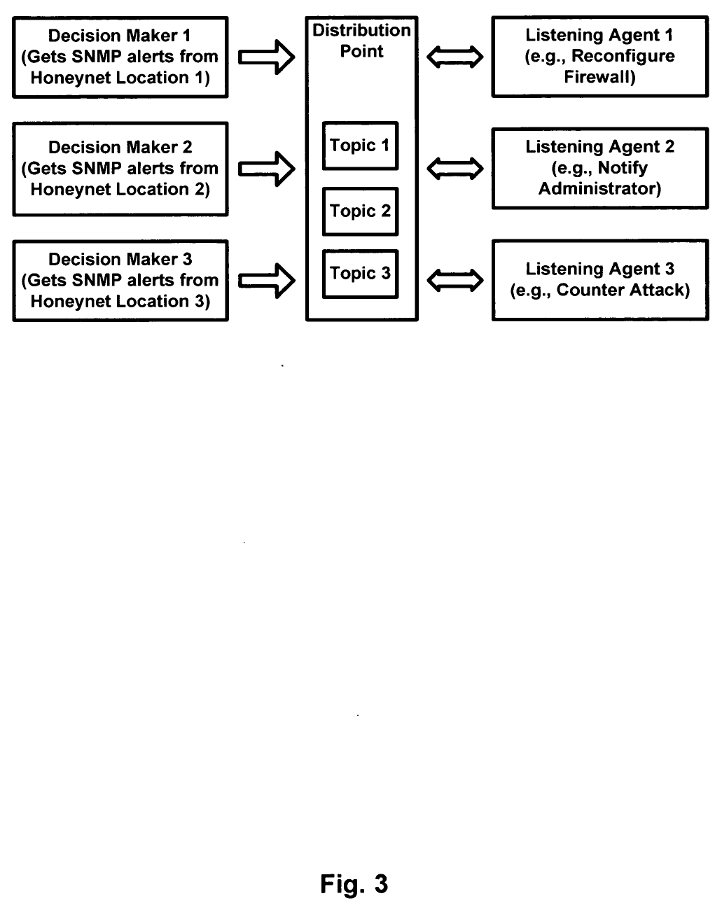

The automatic decision maker can classify (e.g., by grouping, sorting, etc.) and sort received data into a hierarchy of predetermined attributes. Examples of these attributes include, but are not limited to, origin; geography of origin; topic; severity; frequency; time of day; used network protocol; or a combination of the above. Data received may come from a multitude of automatic decision makers, as shown in FIG. 3.

Furthermore, the automatic decision maker can automatically compare attacks/probes and suggest and/or decide appropriate measures (also referred to herein as topics) to take. Examples of topics include, but not limited to, recommending a plan of action, reconfiguring a firewall, notifying the administrator of a potential attack, launching a counterattack or shutting down the system. These topics may be located at one or more distribution points, as indicated in FIG. 3. The distribution point may be secure (i.e., capable of being encrypted). It may also be centralized in the honeynet farm or located at a remote or distributed location.

The client (also referred to as listening agent) may select and request implementation of one or more topics. Upon forwarding the request, the present invention may notify the client that implementation is being or has been executed. The client can either be a human operator (e.g., an administrator) or an operative (e.g., a non-human operator). Examples of an operative include, but are not limited to, a honeynet, production network, virtual network and simulated network.

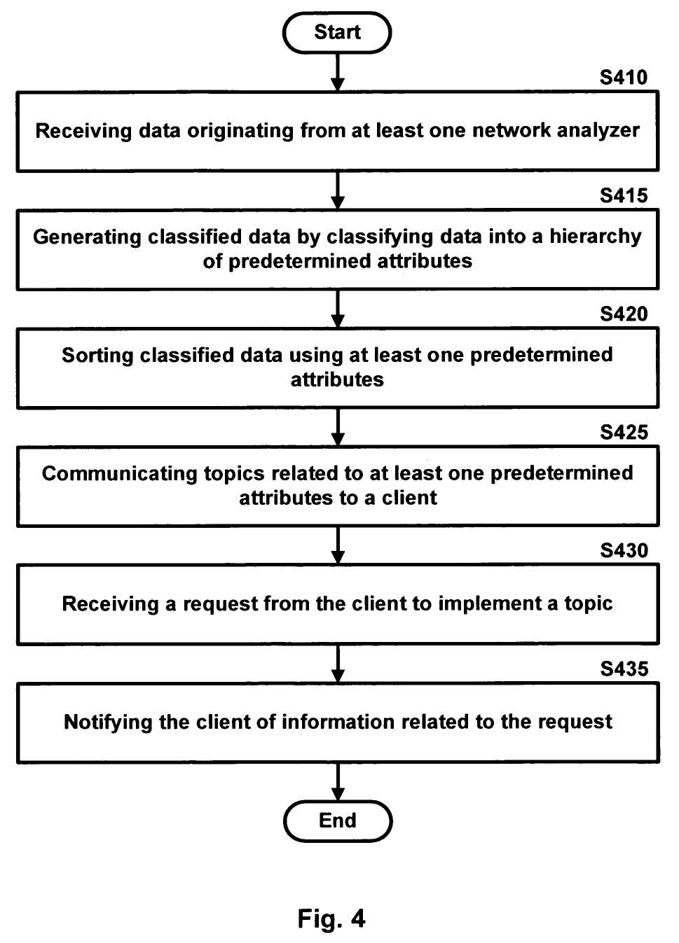

Referring to FIG. 4, in generating automatic decisions in a honeynet farm based actionable early warning system, a tangible computer readable medium may be encoded with instructions that are executable by a computer or computer readable machine, such as a personal digital assistant (PDA), compact disc (cd), cd player, cell phone, usb flash drive, floppy disks, etc. The instructions may be written using any computer language or format. Examples of computer languages or formats include Java, C++, Cobol, XML, etc. The instructions may include receiving data (such as attack or probing data) originating from one or more network analyzers S410. The data that is received may essentially be the same as the previously mentioned correlated results. While each network analyzer may be part of a honeynet, it may well be the case that each network analyzer is alternatively part of a honeynet farm. Furthermore, each network analyzer may be a dependent or independent component of one or more honeynets.

Received data may be classified (e.g., by grouping, by separating, etc.) into a hierarchy of predetermined attributes to generate classified data S415. Again, examples of these attributes include, but are not limited to, origin; geography of origin; topic; severity; frequency; time of day; used network protocol; or a combination of the above. The hierarchy may be set by an administrator according to the administrator's preferences. Once classified, data may be sorted using at least one of these predetermined attributes S420. Furthermore, one or more of these attributes may be placed into a format (e.g., tabular, graphical, chart, alphanumeric, etc.) that can be communicated to a client S425. One purpose of this communication is to permit the client to determine which topic(s) he or she wishes to select and implement. For instance, topics may include, but are not limited to, recommending a plan of action, reconfiguring a firewall, describing the type of data received, notifying the administrator of a potential attack, assessing damage control, launching a counterattack or shutting down the system, etc. Once the topic(s) has been selected, the instructions may permit the computer or computer readable machine to receive from the client a request for one or more of the topics related to the predetermined attributes S430. The computer or computer readable machine may notify the client of information related to the request, such as the presence of an attack, confirmation of enhancing security features, the launching of a counterattack, etc. S435.

The honeynet farm based actionable early warning system may incorporate a multitude of components. These components may include, but are not limited to, one or more of each of the following: router, switch, firewall, server, traffic generator and storage server. For example, as one embodiment, the honeynet farm based actionable early warning system may comprise a Cisco 7204 VXR router, Cisco 2950 switch, Cisco PIX 515E firewall and VPN, Cisco PIX 501 firewall, ten Gateway 935 series servers, four 1U Penguin Computing servers, two Sun ultra park servers, an Arbornet network traffic generator and a Dell Terra byte storage server.

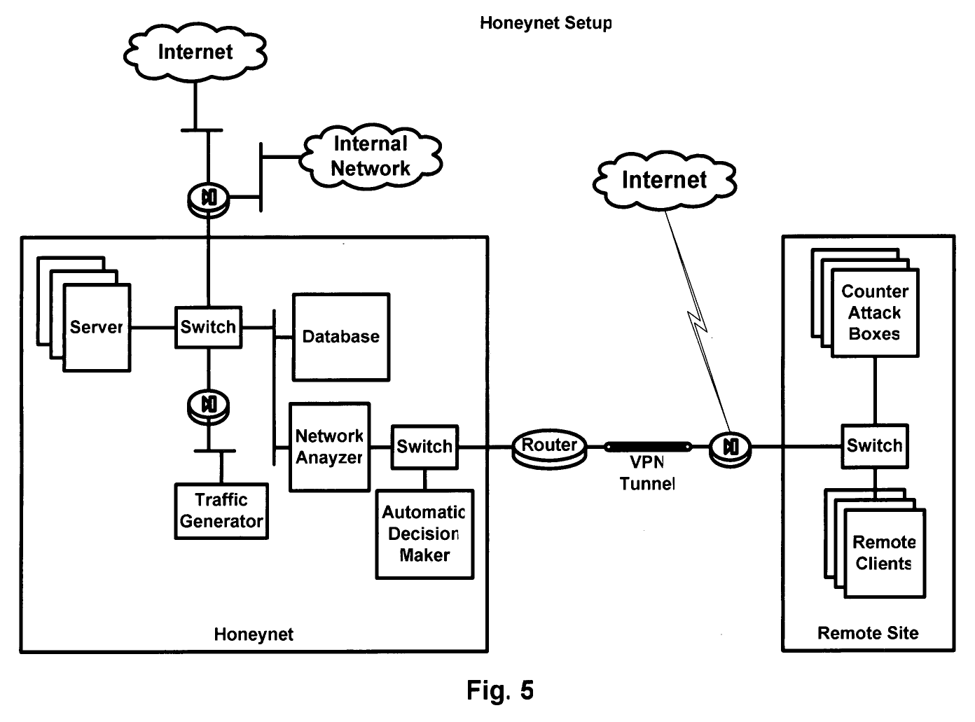

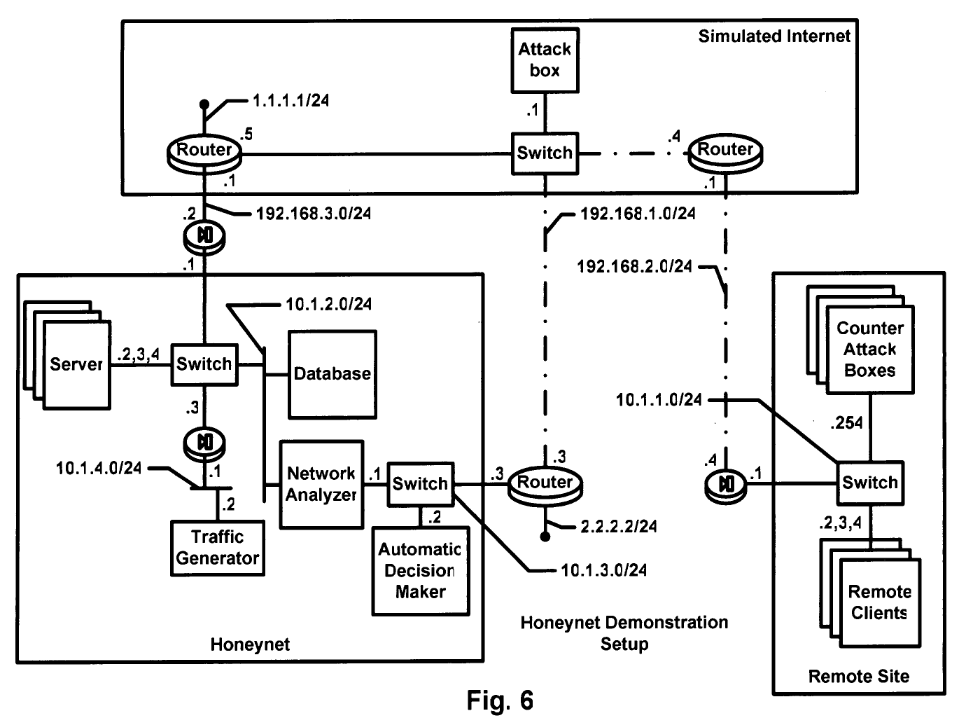

The examples shown in FIGS. 5 and 6 illustrate that the Internet can be directly connected to the Cisco PIX 515E firewall. The DMZ (DMZ 1) on the PIX can be connected to a Cisco 2950 switch. DMZ 1 may host all applicable servers. A single port on the Cisco 2950 switch may be configured as a Span port. The server hosting Snort may be connected to the Span port. This port can also be shared by the Dell Terra byte storage server. The Arbornet traffic generator may be located behind a second firewall (Cisco Pix 501). A purpose of the traffic generator is generating simulated traffic on the DMZ. Services and transactions should all be simulated. Multiple web servers that run high volume transactions may make it more tempting to the intruder. In addition, e-mail servers may be run with IMAP and other mail protocols, because most attacks today are carried out through e-mail and related services. Thus, the intruder can bypass the firewall by tunneling though the e-mail protocol, because a typical firewall does not protect against such e-mail attacks. Such feature is another aspect that may attract intruders.

The Cisco PIX 501 firewall is basically designed to send traffic only outside the system. It usually does not accept any traffic from the honeynet domain. An intruder will therefore likely see traffic flowing only in the honeynet, and not the hidden traffic generator behind the firewall.

The Cisco PIX 515E firewall can have multiple interfaces. One interface can be used for DMZ 1. Logging and monitoring may be performed through the Span port at the Cisco 2950 switch connected to it. The information gathered may be parsed from this port to the monitoring system. To analyze the network traffic, various analytical tools, such as SNORT and TCPDUMP, may be used.

A second interface (e.g., inside interface) may be connected to the existing lab which includes two parts. The first part may comprise of regular computers connected to the Internet. The second part may be separated by a firewall, which would isolate the part from the rest of the network.

Traffic flow policies may be implemented using different filtering rules on the firewalls. For example, the policy may (1) allow HTTP, SMTP, ICMP, etc., to enter into DMZ 1 on the PIX 515E, (2) only allow established traffic into the inside interface of the PIX 515E, but (3) do not allow anything into the PIX 501 from the outside.

The table below exemplifies a sample code on a Cisco PIX 515.

TABLE 1
Sample Code on a Cisco PIX 515E.
Sample Code

interface ethernet0 10baset
interface ethernet1 100 full
Nameif thernet0 outside security0
nameif ethernet1 inside security100
enable password AL8sZHguc0aiRyab encrypted
passwd AL8sZHguc0aiRyab encrypted
hostname STOP
domain-name xyz.com
access-list 101 permit tcp any host 192.168.6.12 eq 4125
access-list 101 permit tcp any host 192.168.6.12 eq https
access-list 101 permit tcp any host 192.168.6.12 eq 444
access-list 101 permit tcp any host 192.168.6.12 eq smtp
access-list 101 permit tcp any host 192.168.6.6 eq 4899
access-list 101 permit tcp any host 192.168.6.80 eq 4899
ip address outside 10.1.10.2 255.255.255.0
ip address inside 192.168.6.1 255.255.255.0
global (outside) 1 interface
nat (inside) 1 0.0.0.0 0.0.0.0 0 0
access-group 101 in interface outside
route outside 0.0.0.0 0.0.0.0 10.1.10.1 1
sysopt connection permit-ipsec

The traffic generator may be used to send attack packets to the honeynet (e.g., maker box) to be developed during the execution phase. When detected, the honeynet may send a notification to an n+1 system. This detection and notification may be achieved programming logic based on the capabilities of the various listing agents on thenetwork analyzer (which may also be referred to as a registry).

Timing delays may be calculated using a data sharing mechanism. The data sharing mechanism may alert a destination system and instate a new policy to safeguard it from the same traffic. This process may be accomplished by sending out a flag thru a linked connection, such as but not limited to a VPN connection. A policy drop (e.g., firewall rules) and reinstate new policy may also be integrated. In systems using non-Cisco firewalls, a policy with a drop and/or reinstating mechanism may be custom developed. Yet, in systems using Cisco firewalls, a flush rule set may be used to instate a new policy.

The Cisco PIX 515E firewalls may sustain traffic of a small size office environment. If a flooding type attack occurs and is undetected, there can be a Denial of Service (DoS) or clogging of the system. To preempt DoS or clogging of the system, the present invention may implement a flushing mechanism at the firewall base. A clear arp command may be used to flush the ARP cache in the PIX 515E firewall.

To use data obtained from the honeynet in securing production networks, the present invention must be able to allow users to collect, understand and react to ongoing traffic. To achieve this goal, modules external to the physical architecture of the honeynet can be essential. The modules may be connected to the honeynet through the span port on the Cisco 2950 switch. This connection aids in capturing traffic on the honeynet segment.

It is preferable to have at least two data collection modules. Generally, independent of the physical technique and the physical location, network traffic comes in the Pcap format. The libpcap library, integrated into many products, is usually able to read data in this format. To read Pcap data systems, softwares, such as TCPDUMP, may be used. TCPDUMP can be redirected to another application or stored for forensic analysis. Alternatively, many analyzers have their own libpcap-based packet capture capability for real-time analysis. It is preferable to use TCPDUMP data for flow-based analysis and real-time packet capture using the Snort intrusion detection engine for signature and anomaly detection.

The present invention may use three types of analysis: signature, statistical anomaly and flow-based.

Signature analysis, the first method implemented in intrusion detection systems, is based on string matching (also referred to as pattern matching). String matching involves comparing an incoming packet with a single signature, which is a string of code that usually indicates a particular characteristic of malicious traffic. Comparisons may be performed byte by byte. The signature may include a phrase or command often associated with an attack. If a match is found, an alert may be generated. If not, data in the packet may be compared to the next signature on the list. Signature comparison may repeat until all the signatures have been checked. Once completed, the next packet may be read into memory, wherein the process of signature checking begins again.

It is preferable to use the Snort intrusion detection engine for the signature-based analysis. Snort is a popular open-source, easily extendable network traffic analysis engine. The distribution may include a fairly broad set of rules (e.g., signatures) and a flexible language for custom rule generation. Snort may also include its own packet capture interface that can take the Ethernet feed off of the switch span port or can be configured to read a TCPDUMP data file. The rule set and configuration may be managed from a remote console. Alert data may be used in a reactionary module.

Statistical anomaly analysis attempt to find intrusions by comparing observed behaviors with models of expected behaviors. The statistical portion may help explain the probability of certain or anticipated behaviors when compared to models. An advantage that statistical anomaly analysis has over signature analysis is that the former can be used to detect new or novel attacks without having to rely on matching observed data with a database of known attacks. In essence, such analysis may aid in real-time detection of intrusions.

It is preferable to use the Statistical Packet Anomaly Detection Engine (SPADE) for the statistical anomaly analysis. SPADE is an open-source application from Silicon Defense that provides an anomaly-based analysis capability. In reality, SPADE is a Snort plug-in that comes with Snort and uses statistics to assign an anomaly score for each packet in an attempt to identify unusual and/or suspicious packets. The anomaly scores may be determined by looking at common sets of packet header field values. For example, packets with destination IP address 192.168.1.10 and destination port 80 may be one kind of packet. However, packets with source IP address 158.187.1.22, destination IP address 192.168.1.10, and the FIN flag set may be another kind of packet. SPADE generally maintains this information in probability tables. Recent events may be weighted more heavily in the probability calculation. Hence, the probability for packets with destination IP address 192.168.1.10 (e.g., a webserver) and destination port 80 may be rather high (P(X)=0.5), meaning half of the network traffic could be directed at the webserver. Yet, the probability of a single outside IP address, 158.187.1.22, sending a packet to the webserver with the FIN flag set may be much lower (P(Y)=0.001). The actual anomaly score may be derived from these probabilities according to the formula
A(X)=−log₂(P(X)) (1)
for a packet X. Thus, for the previous example, A(X)=1, while A(Y)=9.965. The less common event tends to be much more anomalous. SPADE may allow for thresholds to be set, above which it can send alerts to the data repository.

Flow-based analysis generally compares network flow traffic of a honeynet against network flows of a network. In observing network traffic, attention is usually focused on some of the characteristics of malicious traffic, the amount of malicious traffic seen by end users of the Internet, and identifiable sources of malicious traffic. Types of network traffic flows can be based on transport layer protocols (TLP), such as TCP, UDP, ICMP, and IGMP. Flows used can be bi-directional and can be based on 5-tuple, which may include source destination IP addresses, source and destination ports, and TLP. For each flow, statistics gathered may include various time measurements, the number of packets sent and/or received, the source and destination parameters, failure flags, window size requirements, etc. Each flow may even have (1) a local IP and port number and (2) a remote IP and port number. Local often refers to the host on which the client runs and collects statistics. Remote often refers the other host in the flow. After a certain amount of data is collected from the local IP and remote IP, each dataset may be compared and analyzed using a particular format, such as graphs, charts, tables, etc.

For each of these analysis tools, configuration is recommended. Additionally, each is recommended to be managed locally through its native and rudimentary interfaces. However Snort tends to be managed by SnortCenter, a management application that remotely manages the Snort engine's status, configuration and rules sets via a GUI interface. This software may be co-collocated with the Snort engine and may require installing a supporting Apache webserver with PHP scripting capability.

Experiments

The following procedures demonstrate an aspect of the invention and do not represent the only way of practicing the invention.

The present invention may be carried out in two phases. The first phase measures the accuracy of detecting between two kinds of traffic (such as network traffic) in terms of type I and type II errors. The second phase measures the time taken to identify potential alarms. Because it is well known in the art that anomaly based detection methods tend to have a high false alarm rate, it is preferable to assign a low significance score to SPADE alarms.

Measuring detection times and accuracies may help a user to determine the suitability of honeynets. Two important factors that an active network should know are the certainty and the freshness of warnings. FIGS. 1 and 2 show the interaction and data flow between these modules. Streams of TCPDUMP data may be fed into three modules for detecting signatures, anomalies and flows. Their output warnings may be submitted for consideration by the reaction module.

As exemplified in FIG. 6, the experiment may begin with running a production network with a front-end firewall, such as a Cisco PIX 515E. The network may be located at a remote location away from the home network. A VPN session may be established from a honeynet to the remote location. An attack may be sent to the honeynet for testing the response time to reinstate an access list on the remote location. Once the attack is in session, monitoring may be accomplished though a span port using a switch, such as a Cisco 2950 switch. Snort may be run in the interface to monitor traffic. A controlling software may be run in a decision maker box, that can send out a signal through the VPN tunnel from a firewall, such as Cisco PIX 515, to a remote firewall, such as Cisco PIX 515. Another decision maker box, which may be located at another production network, may analyze a code, make a decision, and instate a new access list to the firewall. The experiment may be repeated with production networks with multiple network perimeters and other host based vulnerabilities. The latency of the entire transaction may be measured under different load conditions and may be further optimized.

This experiment assumes that each network has only one point of entry or that all entry points enforce the same policy. Such assumptions allow the network to take greater precautionary measures. However, the present invention may also allow more than one entry point for each network. Similarly, the present invention may allow entry points to enforce multiple policies.

The present invention may also implement security policy changes by dropping a previous policy and instating at least one new policy. The new policy can be a secure or nonsecure policy. Both may have to be pre-written in files. This procedure may be implemented rapidly in one or more firewalls.

The present invention may be enhanced by creating (or instantiating a parameterized access control list) access lists on the fly. These lists may be automatically loaded using a network management system, such as Cisco Works. The network management system may be web-based. Such method may allow users to have a unique access list for every situation and allow the honeynet farm to be more dynamic.

Time may be estimated as an experimental output to determine the effectiveness of the architecture. For example, a user may estimate the time taken to change switch policies. Based on communication relays, attacks that can be avoided due to pre-warnings may be categorized. Also, when data analysis units generate alarms, a user may also estimate the total time taken between launching an attack on the honeynet and the production networks defending themselves by tightening its perimeter. This process may even be repeated under different load conditions and attacks.

Legal Issues

Legal issues may be addressed by investigating the legal aspects of unconsented monitoring of transactions and by implementing possible hack-back rules. The present invention can monitor traffic by parsing header information. It also allows the tracing of traffic origins. Hacking back (or any activity against an intruder) may depend on the location of an attack and/or scan. The present invention may limit hacking back within the confines of a closed system.

Crossing legal boundaries for the purpose of investigating or reacting sometimes depends upon interstate and/or international agreements. Addressing this issue, the present invention may query appropriately populated databases to keep track of the legality of crossing boundaries. Additionally, the present invention may parametrize invasive procedures so that the algorithms that enforce such procedures can succeed if the calling instances result in legal combinations.

Non-Real-Time Activities and Alternative Tools

The Analysis Console for Intrusion Detection (ACID) is an open-source application that may parse a number of different log data formats, including those of Snort and SPADE. Additionally, ACID may display such different log data formats in an easy-to-use web interface. Alerts can be grouped, as well as searched, using a fairly sophisticated query builder. The ACID console may also have the ability to decode packet data included in the alert to show layer-3 and layer-4 header information. ACID may provide some useful visualization capabilities, including graphing alerts over time and charting many kinds of statistics. ACID may require a web server and PHP support, and may also be collocated with a database.

The present invention may require two elements serving as data repositories. One can be used for storing captured network traffic. This repository may require a large amount of storage space, and may be stored in flat files in an existing multi-terabyte storage. Another can be used for supporting structured data, which may aid in analyzing, managing and/or monitoring components. This latter repository may have lesser capacity storage size. For example, the latter repository can be MySQL or PostgreSQL.

Visualization is generally identified as a separate component of the network traffic analysis architecture of the present invention. However, visualization may also be included as a tool in one or more of the network analyzers or in one or more of the analysis consoles. Among examples of software capable of providing significant visualization features include ACID and CoralReef. Additionally, an open-source tool for high-level network traffic visualization, such as Etherape, may be used for displaying each connection between two IP addresses as a line between two points. The lines may be color-coded to indicate different protocols. The size of the endpoints and lines may be used to reference the traffic volume of each connection. Etherape may be installed separately and can feed off a spanning port in real-time. This feed in turn can be directly sent to the decision maker box.

Honeynet Farms and Distributed Experiments

The honeynet described in the present invention can feed data to other systems. The described software modules, which process data streams in the present invention from the proposed honeynet, can process data from more than one honeynet. The present invention may employ a collection of honeynets as a source of warning systems. To accomplish this goal, the capabilities of the decision making unit may be expanded.

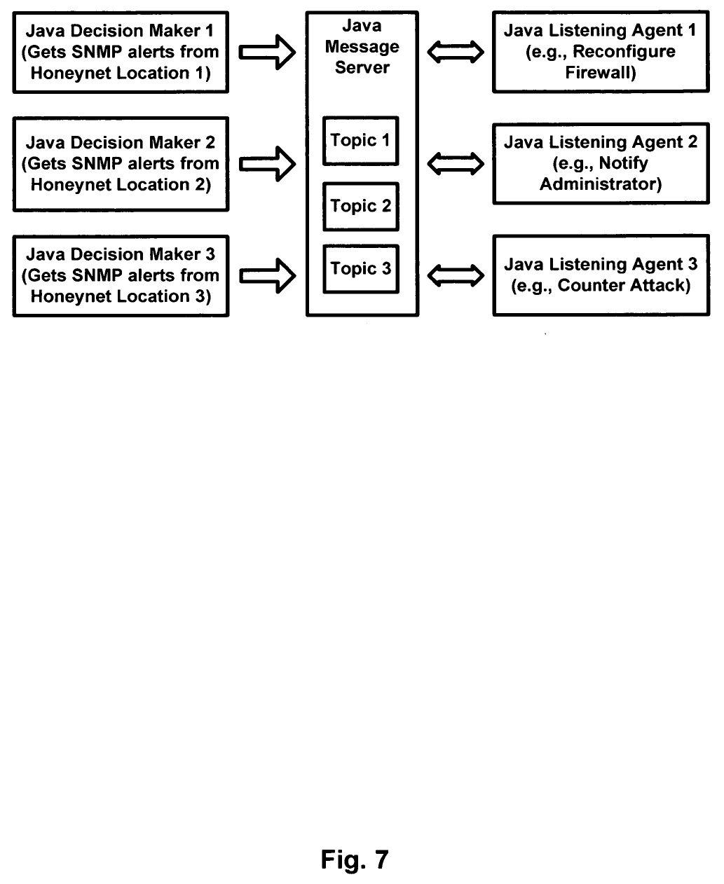

An agent system may be used for managing online alerts and reaction modules. Any kind of computer language or format, such as Java as exemplified in FIG. 7, may be used to create the system. This system may be implemented using a distribution point to send messages between different systems. An example of a distribution point is a Java Message Server (JMS). The detecting agents, such as Snort, Spade, etc., may send notifications to an automatic decision maker, such as Java Decision Maker (JDM). Snort may send SNMP alerts to the JDM. This JDM may be configurable so that it would be possible to setup the JDM to respond to various alerts differently. JDM's primary function tends to be sending JMS messages to the JMS. However, the present invention may use OpenJMS, which is an open source implementation of JMS specifications. OpenJMS can aid in swaping any other JMS implementation in the future. A listening agent, such as a Java Listening Agent (JLA), may complete the response process by listening on the JMS for interested events. These events can be classified based on different queues and topics to which they are sent to be different JDMs. JLAs may communicate with JMS through VPN if the JLAs are external to the system. JMS may operate to guarantee that JLAs will get any interested messages. Depending on the system JLAs are running and what their objectives are, various JLAs may process these messages differently. For example, a JLA that is intended to change firewall settings in response to a particular alert will change the IP table configuration on the system it is running. Codes used in this experiment may be found in the Computer Program Listing Appendix.

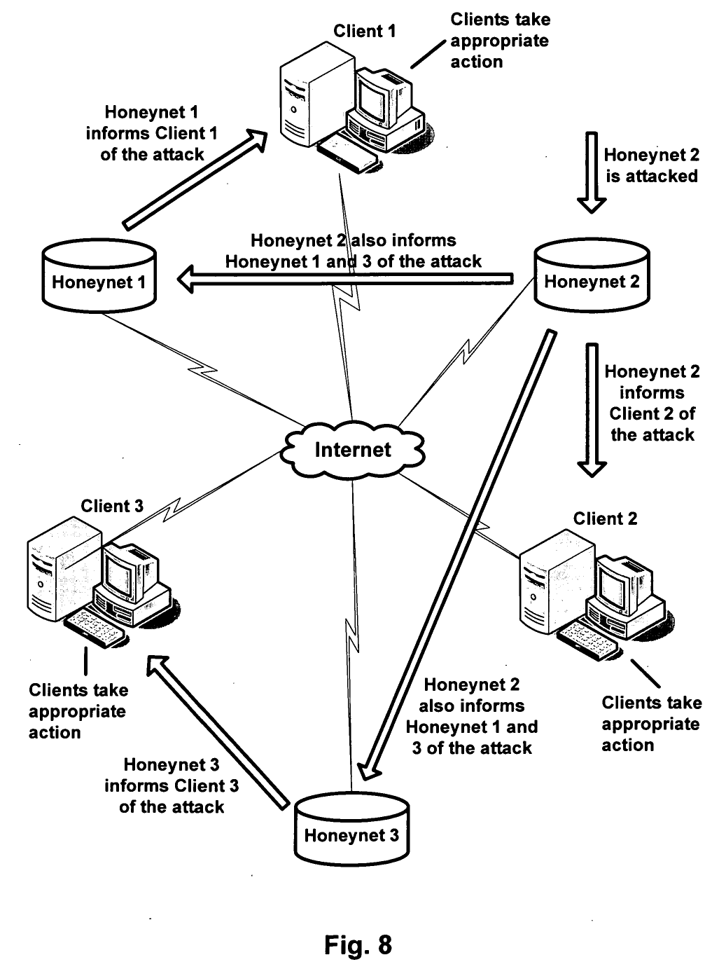

Furthermore, honeynets may be used to communicate with each other through their spam ports as shown in FIGS. 6 and 8. As one embodiment, the present invention may use the Honeyed software based off the shelf product. By dynamically changing perimeter security policies due to automated warnings, one honeynet may adjust its policies based on either internal input (e.g., input received from another honeynet) or external input. For instance, a honeynet (e.g., “Honeynet 1”) may be run in a remote site and configured with a front-end firewall, such as Cisco PIX 515E. A VPN session from Honeynet 1 to a remote honeynet (e.g., “Honeynet 2”) may be established, as shown in FIG. 6. An attack may be sent to Honeynet 1. The response time should be tested to reinstate an access list on Honeynet 2. Another attack may be sent outside the firewall by using a network traffic generator. Once the attack is in session, a user can monitor the session through a Spam port in a switch, such as a Cisco 2950 switch. SNORT may be run in the interface to monitor traffic. A controlling software may be run in a decision maker box. This box may send out a signal through a VPN tunnel from one firewall to another firewall. The decision maker box at another production network end may analyze the code. In its analysis, the decision maker box tends to make a decision and instate a new access list to the firewall. The latency of the transaction can be measured under different load conditions and can also be optimized.

As illustrated in FIG. 8, when a honeynet is attacked, the honeynet may inform its client of the attack so that the client may take appropriate action. Additionally, the attacked honeynet may also inform other honeynets of the attack. A purpose of this communication is to alert other clients of the possibility of receiving the same or similar attack. Perhaps more importantly, the alert can forewarn other clients on appropriate actions to take to prevent such attack.

The foregoing descriptions of the preferred embodiments of the present invention have been presented for purposes of illustration and description. They are not intended to be exhaustive or to limit the invention to the precise forms disclosed, and obviously many modifications and variations are possible in light of the above teaching without departing from the scope of this invention and its broader aspects. The illustrated embodiments were chosen and described in order to best explain the principles of the invention and its practical application to thereby enable others skilled in the art to best utilize the invention in various embodiments and with various modifications as are suited to the particular use contemplated.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. A tangible computer readable medium encoded with instructions for generating automatic decisions in a honeynet firm based actionable early warning system, executable by a machine under the control of a program of instructions, in which said machine includes a memory storing said program, wherein execution of said instructions by one or more processors causes said one or more processors to perform a multitude of steps comprising:
a. receiving data originating from at least one network analyzer, said network analyzer being part of at least one honeynet,
b. generating classified data by classifying said data into a hierarchy of predetermined attributes,
c. sorting said classified data using at least one of said predetermined attributes,
d. communicating topics related to at least one of said predetermined attributes to a client,
e. receiving a request from said client to implement said topics, and
f. notifying said client of information related to said request.

2. A medium according to claim 1, wherein said client is a honeynet.

3. A medium according to claim 1, wherein said client is a production network.

4. A medium according to claim 1, wherein said client is a virtual network.

5. A medium according to claim 1, wherein said client is a simulated network.

6. A medium according to claim 1, wherein said predetermined attributes include:
a. origin,
b. geography of origin,
c. topic,
d. severity,
e. frequency,
f. time of day,
g. used network protocol, or
h. a combination of the above.

7. A medium according to claim 1, wherein an automatic decision maker receives said data.

8. A medium according to claim 1, wherein said topics are located at a distribution point.

9. A medium according to claim 1, wherein said data is analyzed in real-time.

10. A medium according to claim 1, wherein said data is analyzed using signature analysis.

11. A medium according to claim 1, wherein said data is analyzed using statistical anomaly analysis.

12. A medium according to claim 1, wherein said data is analyzed using flow-based analysis.

13. A medium according to claim 1, further including the step of measuring the accuracy of detecting traffic.

14. A medium according to claim 1, further including the step of measuring the time taken to identify potential alarms.

15. A medium according to claim 1, further including the step of implementing security policy changes by dropping a previous policy.

16. A medium according to claim 15, further including the step of instating at least one new policy.

17. A medium according to claim 1, further including the step of enhancing said medium by creating an access list on the fly.

18. A medium according to claim 17, further including the step of automatically loading said access list using a network management system.
